(19) United States
(12) Patent Application Publication
(10) Pub. No.: US 2025/0384492 A1
(43) Pub. Date: Dec. 18, 2025

(54) REAL-TIME CORRELATION OF PERSONALITY TRAITS BASED ON MULTIMODAL INTERACTIONS FOR ACTION ENABLEMENT

(71) Applicant: Openstream Inc., Bridgewater, NJ (US)

(72) Inventor: Rajasekhar Tumuluri, Bridgewater, NJ (US)

(73) Assignee: Openstream Inc., Bridgewater, NJ (US)

(21) Appl. No.: 19/240,320

(22) Filed: Jun. 17, 2025

Related U.S. Application Data
(60) Provisional application No. 63/660,603, filed on Jun. 17, 2024.

(51) Int. Cl. G06Q 40/06; G06Q 30/0203; G06Q 30/0279

(52) U.S. Cl. CPC G06Q 40/06; G06Q 30/0203; G06Q 30/0279

(57) ABSTRACT

Real-time correlation of personality traits based on multimodal interactions for action enablement is described. A method includes collecting multimodal data during venture capital multimodal interactions with an interviewee, where the data includes textual content, vocal characteristics, facial expressions, and behavioral cues of the interviewee, analyzing the collected data to determine individual personality traits and social relationship characteristics, correlating the identified personality traits and the social relationship characteristics with fundraising outcomes, leveraging natural language processing, computer vision and multimodal analysis tools to analyze the intents and behaviors of the interviewee, using a statistical model to determine a probability of funding for the interviewee based on the personality traits, the social relationship characteristics, the intents, and the behaviors, and providing real-time actionable insights and recommendations based on correlation analysis, intent and behavioral assessment, and probability of funding to facilitate decision-making in venture capital investment and fundraising processes.

### CROSS REFERENCE TO RELATED APPLICATION

This application is a continuation of U.S. Application Ser. No. 63/660,603 filed Jun. 17, 2024, of which is incorporated herein by reference.

### BACKGROUND

In the dynamic and competitive world of business, particularly within the realm of venture capital, understanding the personalities and behavioral tendencies of entrepreneurs and business leaders is crucial. Traditional methods of personality assessment, such as interviews and questionnaires, are often limited by their subjective nature and reliance on self-reporting, which can be biased or inaccurate. In addition, these methods are time-consuming and may not provide real-time insights necessary for fast-paced decision-making environments.

The ability to accurately assess personality traits has significant implications for venture capitalists and other business entities. For instance, understanding the personality traits of potential entrepreneurs can aid in evaluating their suitability for investment, predicting their capability to build and run successful companies, and enhancing the transparency and quality of fundraising interactions. This, in turn, can lead to better investment decisions and more efficient business operations.

Despite the potential benefits, there remains a lack of robust systems and methods that can seamlessly integrate multimodal data and provide real-time, actionable insights into personality traits. This gap highlights the need for innovative solutions that can leverage the full potential of machine learning and multimodal data analysis to support business enablement.

### SUMMARY

Described herein is a system and method for real-time correlation of personality traits based on multimodal interactions for action enablement.

In implementations, a method for real-time correlation of personality traits from multimodal interactions for venture capital fundraising including collecting multimodal interactions data during venture capital multimodal interactions with an interviewee, wherein the multimodal interactions data includes at least textual content, vocal characteristics, facial expressions, and behavioral cues of the interviewee obtained from multiple sensors in a multimodal interface used for the venture capital multimodal interactions, analyzing the collected multimodal interactions data to determine individual personality traits and social relationship characteristics, correlating the identified personality traits and the social relationship characteristics with fundraising outcomes, leveraging natural language processing, computer vision and multimodal analysis tools to analyze the intents and behaviors of the interviewee during the venture capital multimodal interactions, using a statistical model to determine a probability of funding for the interviewee based on the personality traits, the social relationship characteristics, the intents, and the behaviors, and providing real-time actionable insights and recommendations based on correlation analysis, intent and behavioral assessment, and probability of funding to facilitate decision-making in venture capital investment and fundraising processes.

### BRIEF DESCRIPTION OF DRAWINGS

The various embodiments of the disclosure will hereinafter be described in conjunction with the appended drawings, provided to illustrate, and not to limit, the disclosure, wherein like designations denote like elements, and in which:

FIG. 1 is a block diagram of an example of a computing device in accordance with the embodiments of this disclosure.

FIG. 2 is a block diagram of an example system in accordance with embodiments of this disclosure.

FIG. 2A is a block diagram of an example multimodal recognizer in accordance with embodiments of this disclosure.

FIG. 2B is a block diagram of an example correlation engine in accordance with embodiments of this disclosure.

FIG. 3 is a multimodal interface for use with the system in accordance with embodiments of this disclosure.

FIG. 4 is a flowchart of an example method for real-time correlation of personality traits based on multimodal interactions for action enablement in accordance with embodiments of this disclosure.

FIGS. 5A and 5B are examples of graphs illustrating output in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and methods for discovering personality traits from multimodal interactions by venture capitalists to enable business operations for an entity. The system provided leverages advanced algorithms and machine learning techniques to analyze diverse data inputs, including textual content, vocal characteristics and intonations, facial expressions, behavioral cues, and social interactions. By synthesizing these multimodal data sources, the system determines individual personality traits based on established psychological frameworks such as the Big Five personality model. The resulting personality profiles are utilized to enhance various business processes, including fundraising. The methods provided assess behavioral biomarkers by correlating the quality of fundraising interactions with the capability to build and run a company with greater transparency. These methods ensure a robust framework for real-time analysis and actionable insights, enhancing fundraising operations' overall efficiency and effectiveness.

In implementations, the system and methods provide multimodal conversational artificial intelligence with a focus on personality assessment and business analytics. Specifically, the system and methods discover personality traits through the analysis of multimodal interactions. In implementation use cases, the system and methods can be applicable to venture capitalists and other business entities seeking to enhance their operations, such as fundraising. The system aims to provide real-time analysis and actionable insights to improve the efficiency and effectiveness of various business processes.

With the advent of advanced technologies in statistical, machine learning, and multimodal data analysis, there is an opportunity to revolutionize the way personality traits are discovered and analyzed. Multimodal interaction analysis, which encompasses textual content, vocal characteristics, facial expressions, and behavioral cues, offers a comprehensive and objective means of assessing personality traits. By integrating various modalities and social characteristics and employing sophisticated algorithms, it is possible to obtain a more accurate and holistic understanding of an individual's personality.

In implementations, the system and methods discover personality traits from multimodal interactions and social interaction data characteristics. In implementations, the system is designed to facilitate venture capital interviews for fundraising between investors and company holders. A company uploads a presentation and engages in interactions with venture capitalists through multimodal means, including a series of questions and interviews conducted via video call. By utilizing statistical, machine learning, and multimodal data analysis, and established psychological frameworks, the system uses these methods to enhance business processes, particularly in the context of venture capital and fundraising operations.

Personality traits refer to enduring patterns of thoughts, feelings, and behaviors that distinguish individuals from one another. These traits are relatively stable over time and across different situations, forming a core part of a person's identity.

Psychologists often categorize personality traits into various models to better understand and describe human behavior. From the perspective of psychological behavior, there is a 5-factor personality traits assessment that comprises: (a) Openness to Experience, (b) Conscientiousness, (c) Extraversion, (d) Agreeableness, and (e) Neuroticism. These factors are assessed by extracting personality type features and visible biomarkers.

Openness to Experience encompasses characteristics such as imagination, insight, creativity, and a willingness to try new things with a broad range of interests. People high in openness are often adventurous, creative, and open to new ideas and experiences, while those low in this trait may prefer routine and are more practical. The behavioral markers include, but are not limited to, engaging in diverse activities, frequent changes in hobbies or interests, distinctive fashion choices. The facial expressions can include, but is not limited to, more animated and varied facial expressions, indicating curiosity and engagement with new experiences.

Conscientiousness involves high levels of thoughtfulness, good impulse control, and goal-directed behaviors. The persons having this factor possess characteristics such as being well organized, dependable, and disciplined. Highly conscientious people are often goal-oriented, meticulous, and reliable. Those low in this trait might be more spontaneous and less structured. The behavioral markers include, but are not limited to, organized and tidy appearance, punctuality, methodical and deliberate actions. The facial expressions can include, but is not limited to, well-groomed, wearing practical and clean attire, maintaining a structured environment.

Extraversion comprises characteristics like excitability, sociability, talkativeness, assertiveness, and high emotional expressiveness. Extraverts are energetic and thrive in social situations, and tend to be outgoing, whereas introverts are more reserved and may prefer solitary activities. The behavioral markers include, but are not limited to, frequent social interactions, energetic body language, and tendency to initiate conversations. The facial expressions can include, but is not limited to, more frequent smiling and expressive eye contact, indicating sociability and enthusiasm.

Agreeableness reflects individual differences in general concern for social harmony. Agreeable individuals are often compassionate, cooperative, trustworthy, and friendly. Those high in agreeableness are often empathetic, considerate, and good-natured. Those low in agreeableness may be more competitive and sometimes challenging to get along with. The behavioral markers include, but are not limited to, cooperative and helpful behavior, tendency to avoid conflict, frequent acts of kindness. The facial expressions can include, but is not limited to, warm and friendly expressions, including frequent smiling and nodding, demonstrating empathy and approachability.

Neuroticism relates to emotional instability, anxiety, moodiness, and the tendency to experience negative emotions. High levels of neuroticism are associated with anxiety, moodiness, and irritability and experience more frequent and intense negative emotions such as stress, worry, and sadness. Those low in this trait are generally more emotionally stable. The behavioral markers include, but are not limited to, visible signs of stress or anxiety, such as nail-biting or fidgeting, frequent mood changes. The facial expressions can include, but is not limited to, furrowing.

The above 5-factor trait model provides a framework for understanding the complexities of human personality and can help in various areas, including fundraising operations, investment decisions, psychological assessment, career counseling, and personal development.

In implementations, individual personality traits can be determined based on the Myers-Briggs Type Indicator (MBTI) framework, which categorizes individuals into 16 distinct personality types across four dichotomies: (a) Extraversion vs. Introversion, (b) Sensing vs. Intuition, (c) Thinking vs. Feeling and (d) Judging vs. Perceiving.

With Respect to (a) Extraversion (E) Vs. Introversion (I)

For extraversion, the behavioral markers include, but are not limited to, actively seeking social interactions, frequent participation in group activities, and initiating conversations. The physical markers include, but are not limited to, open body language, frequent smiling, and engaging eye contact.

For introversion, the behavioral markers include, but are not limited to, preference for solitary activities or small groups, thoughtful and reflective demeanor, more reserved in social settings. The physical markers include, but are not limited to, more closed or neutral body language, fewer but more intense facial expressions.

With Respect to (b) Sensing (S) Vs. Intuition (N)

For sensing, the behavioral markers include, but are not limited to, attention to detail, focus on practical and concrete information, preference for hands-on activities. The physical markers include, but are not limited to, organized and practical appearance, engaging in activities that involve tangible results.

For intuition, the behavioral markers include, but are not limited to, focus on abstract concepts and future possibilities, imaginative and theoretical thinking, preference for brainstorming and creative tasks. The physical markers include, but are not limited to, more eclectic or unconventional appearance, engaging in activities that stimulate the imagination.

With Respect to (c). Thinking (T) Vs. Feeling (F)

For thinking, the behavioral markers include, but are not limited to, logical and analytical approach to problem-solving, prioritizing objectivity and fairness, direct and assertive communication style. The physical markers include, but are not limited to, efficient and functional appearance, engaging in debates or discussions.

For feeling, the behavioral markers include, but are not limited to, emphasis on harmony and empathy, prioritizing personal values and relationships, warm and considerate communication style. The physical markers include, but are not limited to, friendly and approachable appearance, engaging in activities that involve helping others or fostering connections.

With Respect to (d) Judging (J) Vs. Perceiving (P)

For judging, the behavioral markers include, but are not limited to, preference for structure and planning, decisive and organized approach to tasks, setting and following schedules. The physical markers include, but are not limited to, neat and orderly appearance, using planners or to-do lists.

For perceiving, the behavioral markers include, but are not limited to, preference for flexibility and spontaneity, adaptable and open-ended approach to tasks, comfort with last-minute changes. The physical markers include, but are not limited to, casual or varied appearance, engaging in spontaneous activities or multitasking.

The system and method uses the personality traits frameworks for analyzing psycho-demographic profiles of individuals from digital footprints of behavior. Personality traits play a crucial role in determining the success of a venture, influencing various aspects of its operations and outcomes. The system and methods discover personality traits from multimodal interactions to facilitate business enablement, particularly in the context of venture capital interviews for fundraising. The resulting personality profiles are utilized to enhance various business processes, such as but not limited to, improving the transparency and quality of fundraising interactions between investors and company holders.

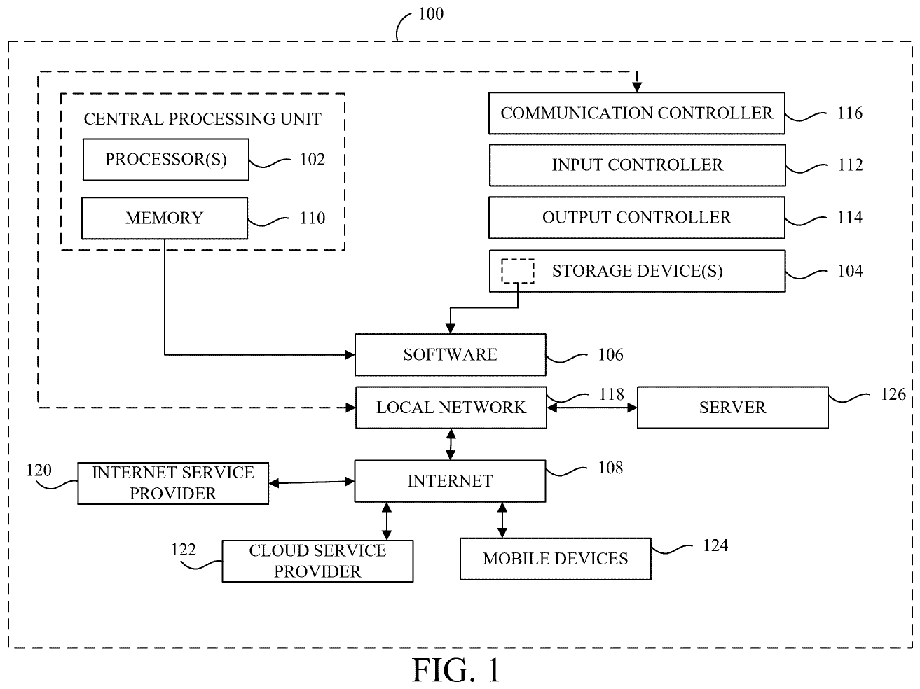

FIG. 1 is a block diagram of a system that comprises a computing device 100 to which the present disclosure may be applied according to an embodiment of the present disclosure. The system includes at least one processor 102, designed to process instructions, for example computer readable instructions (i.e., code) stored on a storage device 104. By processing instructions, processor 102 may perform the steps and functions disclosed herein. Storage device 104 may be any type of storage device, for example, but not limited to an optical storage device, a magnetic storage device, a solid-state storage device, or a non-transitory storage device. The storage device 104 may contain software 106 which may include a set of instructions (i.e., code). Alternatively, instructions may be stored in one or more remote storage devices, for example storage devices accessed over a network or the internet 108. The computing device 100 also includes an operating system and microinstruction code. The various processes and functions described herein may either be part of the microinstruction code, part of the program, or a combination thereof, which is executed via the operating system. Computing device 100 additionally may have memory 110, an input controller 112, and an output controller 114 and communication controller 116. A bus (not shown) may operatively couple components of computing device 100, including processor 102, memory 110, storage device 104, input controller 112, output controller 114, and any other devices (e.g., network controllers, sound controllers, etc.). Output controller 114 may be operatively coupled (e.g., via a wired or wireless connection) to a display device such that output controller 114 is configured to transform the display on display device (e.g., in response to modules executed). Examples of a display device include, and are not limited to a monitor, television, mobile device screen, or touch-display. Input controller 112 may be operatively coupled via a wired or wireless connection to an input device such as a mouse, keyboard, touch pad, scanner, scroll-ball, or touch-display, for example. An input device (not shown) is configured to receive input from a user and transmit the received input to the computing device 100 vial the input controller 112. The input may be provided by the user through a multi-modal interface-based computer-implemented tool. These inputs are, but not limited to, images, speech, audio, text, facial expressions, body language, touch, scanned object, and video. The communication controller 116 is coupled to a bus (not shown) and provides a two-way coupling through a network link to the internet 108 that is connected to a local network 118 and operated by an internet service provider (ISP) 120 which provides data communication services to the internet 108. A network link may provide data communication through one or more networks to other data devices. For example, a network link may provide a connection through local network 118 to a host computer, to data equipment operated by the ISP 120. A cloud service provider 122 and mobile devices 124 provides data store and transfer services to other devices through internet 108. A server 126 may transmit a requested code for an application through internet 108, ISP 120, local network 118 and communication controller 116. FIG. 1 illustrates computing device 100 with all components as separate devices for ease of identification only. Each of the components shown in FIG. 1 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be implemented as one or more servers, for example a farm of networked servers, a clustered server environment, or a cloud network of computing devices.

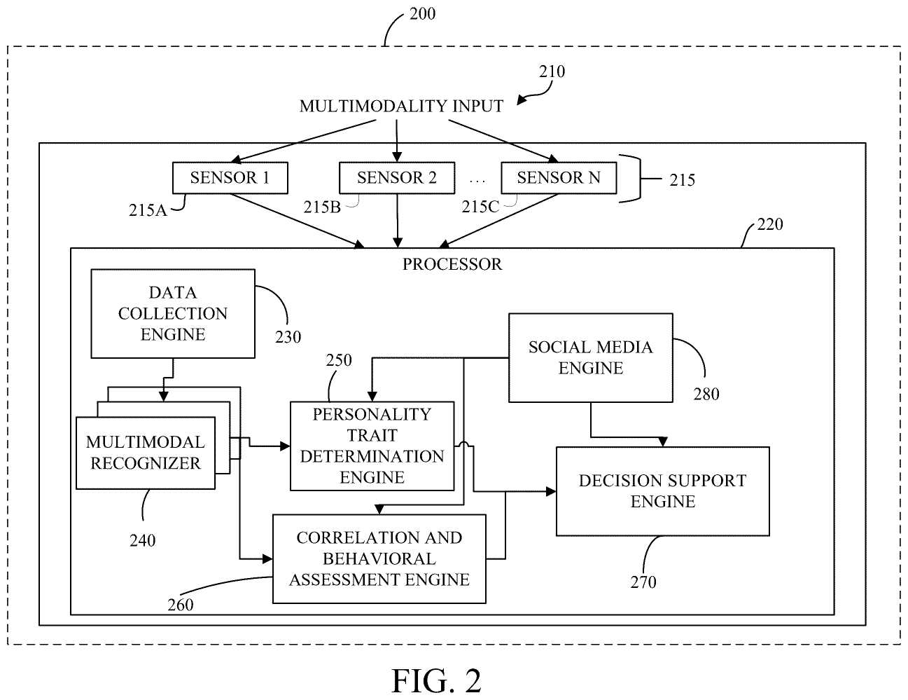

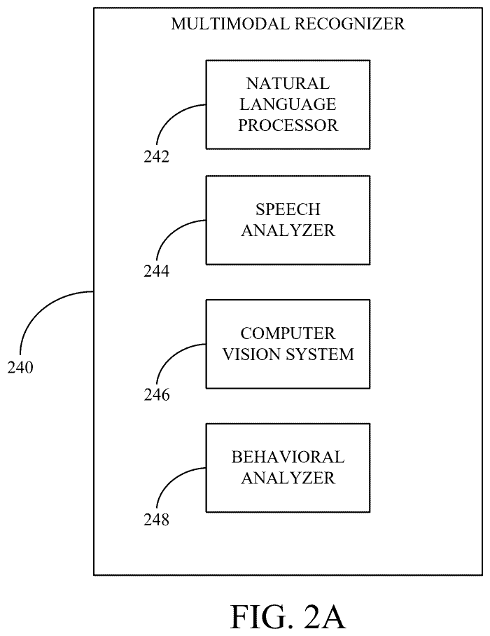

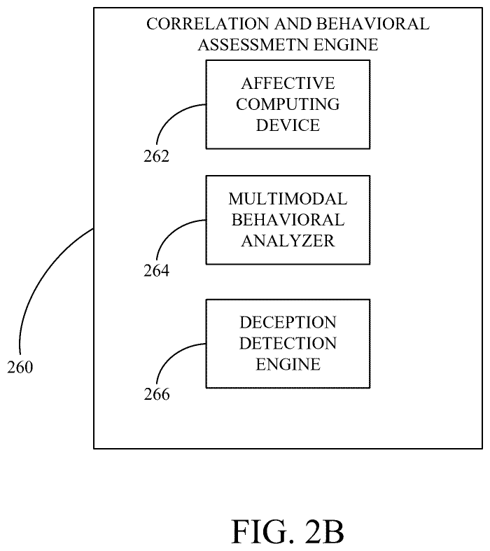

FIG. 2 is a block diagram of an example system 200 in accordance with embodiments of this disclosure. The system 200 can include, but is not limited to, sensors 215 connected to or in communication with (collectively “connected to”) a processor 220. The sensors 215 can include, but is not limited to, a sensor 1 215A, a sensor 2 215B, and a sensor N 215C. The processor 220 can include, but is not limited to, a data collection engine 230, a data processing and analysis module or multimodal recognizer 240, a personality trait determination engine 250, a correlation and behavioral assessment engine 260, a decision support engine 270, and a social media engine 280.

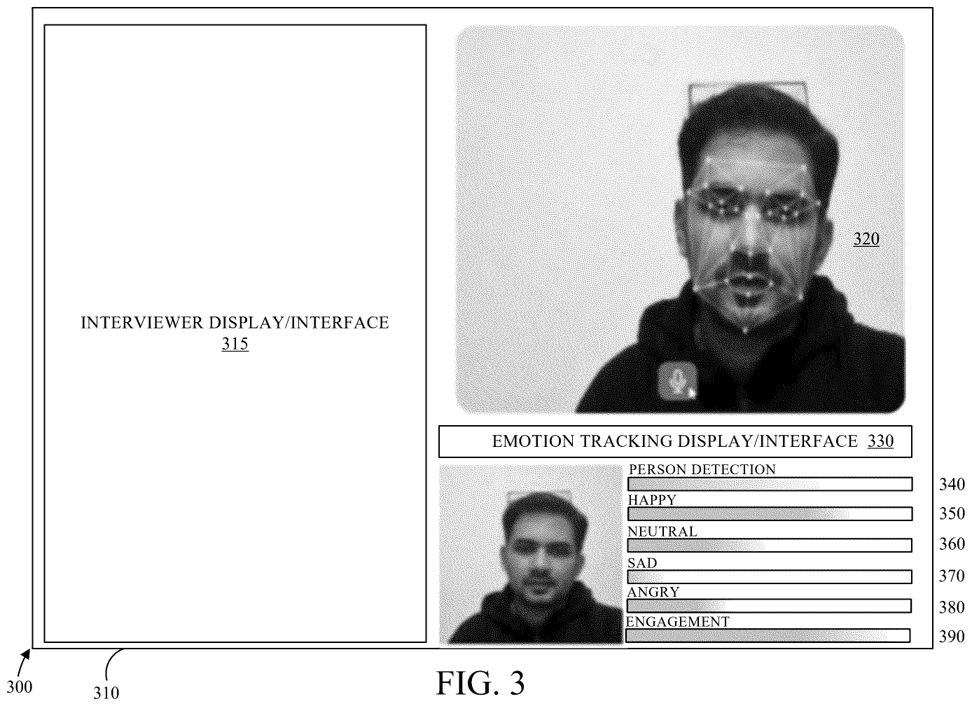

In implementations, the sensor 1 215A, the sensor 2 215B, and the sensor N 215C can obtain multimodal input 210 such as, but not limited to, utterances, speech, text, touch-based input, gestures, facial expressions, audio, video, body language, visual, body postures, eye gaze, lip reading, images, and/or other modalities. The sensor 1 215A, the sensor 2 215B, and the sensor N 215C can be, but is not limited to, cameras, microphones, touchscreens, image sensors, and/or input devices configured to capture interviewee data and/or interviewee multimodal input. The sensor 1 215A, the sensor 2 215B, and the sensor N 215C can be implemented as or part of the multi-modal interface-based computer-implemented tool discussed in FIG. 1 and shown as a multimodal interface 310 in FIG. 3, which is a video conference device or platform or computing device 300 that can implement or use the system 200 in accordance with embodiments of this disclosure. In implementations, the computing device 300 can be or include the computing device 100 of FIG. 1.

Referring now also to FIG. 3, the multimodal interface 310 can include, but is not limited to, the sensor 1 215A, the sensor 2 215B, the sensor N 215C, an interviewer display and/or interface 315 which can display an image and/or video associated with an interviewer or similar party or entity, an interviewee display and/or interface 320 which can display an image and/or video associated with an interviewee and can be used by the system 200 to obtain, for example, facial expressions, an emotion tracking display and/or interface 330 for visually tracking and/or presenting different interviewee parameters, including but not limited to, a person detection parameter 340, a happy expression parameter 350, a neutral expression parameter 360, a sad expression parameter 370, an angry expression parameter 380, and an engagement expression parameter 390. In implementations, the parameters can be determined by the system 200 from the multimodal data or multimodal input 210 obtained via the sensor 1 215A, the sensor 2 215B, and the sensor N 215C in cooperation with the data collection engine 230.

In implementations, the data collection engine 230 can facilitate the collection of multimodal data during interactions such as, but not limited to, venture capital interviews, via the sensor 1 215A, the sensor 2 215B, and the sensor N 215C. The data collection engine 230 and the sensor 1 215A, the sensor 2 215B, and the sensor N 215C can capture (a) textual content from the transcripts of spoken words during video calls, (b) vocal characteristics and intonations based on tone, pitch, and speed of speech, (c) facial expressions based on micro-expressions and facial movements detected through video analysis, and (d) behavioral cues from body language and gestures.

In implementations, the multimodal recognizer 240 can process the collected data using one or more advanced algorithms and machine learning techniques. The multimodal recognizer 240 can process the collected data to analyze and/or determine an applicant's intentions.

Reference is also made to FIG. 2A, which is an example block diagram of the multimodal recognizer 240 in accordance with embodiments of this disclosure. The multimodal recognizer 240 can include, but is not limited to, a natural language processor 242, an automatic speech recognizer (ASR) or speech analyzer 244, a gesture recognizer, a facial recognizer and/or a computer vision system 246, and a behavioral analyzer 248. Each of these sub-components is configured to extract structured data and semantic meaning from unstructured multimodal data or multimodal input 210 collected during the video interviews between interviewees and interviewers, such as venture capitalists. In some implementations, the natural language processor 242 is configured to or can analyze the textual content of the interactions to interpret and understand the interactions with the help of transcribed audio (obtained from the speech analyzer 244) and/or user-uploaded documents such as pitch decks. The natural language processor 242 uses pre-trained transformer based models, such as BERT, fine-tuned on domain-specific corpora related to business venture capital and influence discourse. The natural language processor 242 performs sentiment analysis, emotion detection, semantic intent classification, and named entity recognition. Fine-tuning may involve supervised training on labeled interaction transcripts annotated for affective and intent-based attributes, using datasets curated from prior investment meetings. The speech analyzer 244 can evaluate vocal characteristics and intonations to understand the content, sentiment, and context of the interactions. The speech analyzer 244 first transcribes spoken language into text using an end-to-end neural speech recognition model, such as Wav2Vec and DeepSpeech models. In addition to transcription, the speech analyzer 244 extracts paralinguistic features (such as pitch, tone, speech rate, pause duration, vocal stress, and articulation clarity) using audio signal processing combined with models like LSTM-based acoustic emotion classifiers. These features support sentiment and emotional state inference, as well as stress and confidence estimation. The computer vision system 246 can detect and interpret facial expressions and micro-expressions from the interactions. The computer vision system 246 includes the facial recognizer which is configured to analyze visual data from the interviewee's face and upper body. It employs Convolutional Neural Networks meet Vision Transformer (CMT) trained for facial landmark detection, facial action unit classification, and micro-expression recognition. Models such as EmotionNet and CNN-RNN hybrids are used to detect emotional states and transient expressions indicative of affect, hesitation, or discomfort. The behavioral analyzer 248 can assess body language and other behavioral cues to assist in the understanding of the content, sentiment, and context of the interactions. The behavioral analyzer 248 performs temporal integration and cross-modal synthesis of the extracted signals by using Temporal Convolutional Networks to track behavioral sequences across time, combining facial, vocal, linguistic, and gestural features. The behavioral analyzer 248 may also use multimodal transformers and multimodal autoencoders trained on synchronized multimodal interaction datasets. The training of these sub-components follows a multi-phase deep learning pipeline, including but not limited to, pre-training on large open-domain datasets for general emotion, sentiment, and behavior modeling, fine-tuning on domain-specific datasets, including annotated video recordings of fundraising interactions, to specialize the models for the investor-founder interview context, and validation using cross-modal consistency metrics and manually verified psychological assessments to ensure alignment with ground truth personality and behavior labels.

In implementations, the personality trait determination engine 250 can synthesize the processed data from the multimodal recognizer 240 and components therein to determine personality traits for the interviewee based on psychological frameworks, namely 5-factor and MBTI. In implementations, the personality trait determination engine 250 can be implemented with a machine learning model trained on psychological frameworks and models and data representative of personality traits used for one or more of the psychological frameworks and models.

In implementations, the correlation and behavioral assessment engine 260 can correlate the quality of the interactions (i.e., the fundraising interview interactions) with the capability of building and running a successful company and can provide a behavioral assessment of the interviewee. Reference is also made to FIG. 2B, which is an example block diagram of the correlation and behavioral assessment engine 260 in accordance with embodiments of this disclosure. The correlation and behavioral assessment engine 260 can include, but is not limited to, an affective computing device 262, a multimodal behavioral analyzer 264, and a deception detection engine 266. The affective computing device 262 can evaluate the emotional state and affective responses of the interviewee based on the processed data from the multimodal recognizer 240. The multimodal behavioral analyzer 264 can integrate insights from different data sources (i.e., the processed multimodal data from the multimodal recognizer 240) for a holistic assessment. That is, the data sources are the outputs (processed features/metrics) from various multimodal streams handled and structured by the multimodal recognizer 240. Thus, in implementations, the data sources refer to the “processed multimodal data” from the multimodal recognizer 240. This includes data that has already been collected and processed from various modalities such as textual content (e.g., spoken words or written answers), vocal characteristics and intonation (e.g., pitch, tone, hesitations), facial expressions and micro-expressions (e.g., emotion indicators, eye contact), behavioral cues (e.g., gestures, posture, timing), and social signals (where the system captures inputs from social platforms or past interactions). The multimodal recognizer 240 handles the initial processing and extraction of features from raw input signals across these multiple modalities. The multimodal behavioral analyzer 264 works with the distinct streams of processed information from each of those modalities (e.g., a vocal sentiment score, a facial emotion timeline, text-based intent extraction). In implementations, the data sources can refer to external or raw data sources directly (like social media platforms or databases) and passed through processing stages similar to the multimodal recognizer 240. The deception detection engine 266 can identify potential deception or inconsistencies in responses captured in the processed data from the multimodal recognizer 240.

In implementations, the affective computing device 262 is configured to evaluate the emotional state and affective responses of an interviewee based on real-time data comprising speech, facial expressions, and textual language cues. The affective computing device 262 receives input data that includes, but is not limited to, facial action units (FAUs) obtained via facial expression analysis algorithms, acoustic features such as vocal tone, pitch, and amplitude variation extracted via audio signal processing techniques, and linguistic features indicative of sentiment or emotion obtained via natural language processing (NLP). The affective computing device 262 employs a plurality of machine learning models, including deep neural network models, trained to classify and quantify emotional states. For example, these can include a convolutional neural network (CNN) may be used to perform facial emotion recognition, receiving as input a sequence of facial landmark coordinates and/or video frames extracted from the video stream, recurrent neural networks (RNNs), including long short-term memory (LSTM) networks, transformer-based audio models used to process Mel-frequency cepstral coefficients (MFCCs) and spectrogram representations of speech for audio-based emotion recognition, and transformer-based language models, such as RoBERTa, fine-tuned on emotion classification tasks to analyze text-based interactions, identifying emotional states such as happiness, sadness, anger, fear, surprise, disgust, and neutrality. The output of the affective computing device 262 comprises a multidimensional emotional state vector for each temporal segment of interaction. In some embodiments, the vector may conform to a valence-arousal-dominance (VAD) emotion model.

In implementations, the multimodal behavioral analyzer 264 is configured to generate a comprehensive behavioral assessment by integrating insights derived from multiple modalities, including text, audio, visual cues, and social relationship data. This component may operate in conjunction with early fusion and late fusion architectures. In early fusion, features extracted from each modality are concatenated into a unified feature representation and input into a deep learning model. In late fusion, each modality is processed independently using specialized models, and the outputs are aggregated at the decision level using ensemble learning techniques. The multimodal behavioral analyzer 264 may utilize multimodal machine/deep learning architectures, such as a multimodal transformer or multimodal variational autoencoder, to align and interpret asynchronous data streams. These models may be pre-trained on large-scale multimodal emotion and social interaction datasets and subsequently fine-tuned on domain-specific data related to venture capital fundraising interactions. In some embodiments, Bayesian network models and/or graph neural networks (GNNs) may be employed to model the relationships between behavioral signals and social network traits such as influence, connectedness, persuasiveness, and trustworthiness. The output of the multimodal behavioral analyzer 264 includes, but is not limited to, a normalized behavioral scorecard (comprising traits such as confidence, openness, leadership, and trustworthiness) and a correlation score (reflecting the similarity of the interviewee's behavioral profile to archetypes of historically successful entrepreneurs or founders).

In implementations, the deception detection engine 266 is configured to detect signals indicative of deception or inconsistencies during the interview or fundraising interaction. The deception detection engine 266 receives input features including, but not limited to visual cues such as gaze shifts, blink rates, and facial micro-expressions, audio cues such as speech pauses, speech rate fluctuations, and disfluencies, and linguistic cues such as semantic inconsistencies, hedging, or indirect language patterns. In implementations, the deception detection engine 266 applies BiLSTM (bidirectional long short-term memory) models for sequential analysis of gaze and voice patterns, and transformer-based NLP models trained on deception detection corpora to identify deceptive language. In implementations, the deception detection engine 266 further employs a hybrid model that combines rule-based heuristics (e.g., gaze aversion+long speech pause+uncertainty keywords) with statistical machine learning classifiers. The output of the deception detection engine 266 may comprise a deception likelihood score and/or annotated temporal segments indicating where deceptive behavior is most likely to have occurred.

The outputs of the affective computing device 262, multimodal behavioral analyzer 264, and deception detection engine 266 may be further integrated with a statistical modeling layer, such as a probit regression model, to estimate the probability of successful fundraising. In one embodiment, the Probit Regression Model is configured to estimate the probability of fundraising success (P(success)) based on behavioral and personality indicators derived from multimodal analysis. The input features to the probit regression model may include, but not limited to, personality scores, emotion scores, social influence metrics and behaviors cues. The model uses a Gaussian cumulative distribution function to represent the probability of success P(success):

$$P ( y = 1 \vert X ) = Φ ( X β )$$

where Φ is the cumulative normal distribution of the standard normal distribution and β represents the set of weights (or coefficients) learned during training.

In implementations, the model is further configured to compute the change in likelihood of raising funds for a one standard deviation increase in a specific personality trait. This change is expressed as an odds ratio, thereby enabling interpretable, quantitative measure of influence of individual traits on fundraising outcomes.

In implementations, the decision support engine 270 can provide real-time actionable insights and recommendations based on the personality profiles from the personality trait determination engine 250 and the behavioral assessments from the correlation and behavioral assessment engine 260. The real-time actionable insights and recommendations can drive a determination of likelihood of successful funding and a potential success of the company in building and running operations effectively by the interviewee. The decision support engine 270 can provide insights into the potential success of entrepreneurs and their businesses, aiding in better investment decisions.

In some embodiments, the decision support engine 270 uses ensemble learning models to combine outputs from multiple models and inference engines. These may include (a) a meta-classifier trained on aggregated features (e.g., personality scores, deception likelihood, social connectedness, affective metrics) using XGBoost or Random Forests to provide probability estimates of funding success, (b) a ranking model to rank candidates or ventures based on comparative success likelihood given a particular funding cohort or domain vertical (e.g., healthcare, fintech, etc.), a survival analysis and time-to-event regression models (e.g. Cox Proportional Hazards model) to estimate the probability and time window of successful business targets based on personality-behavior profiles, and (d) a multi-objective reinforcement learning model employed to learn optimal policy recommendations (e.g., whether to invest now or wait for more information), balancing short-term funding decisions with long-term business viability forecasts. The training process for the decision support engine 270 includes dataset construction from historical data from recorded venture capital interviews, annotated with outcomes (e.g., funded/not funded, amount raised, subsequent performance). The features for training include personality vectors (from engine 250), affective/emotional profiles, behavioral patterns (from engine 260), and social graph attributes. A plurality of ML and DL techniques are used for model training, including but not limited to, classification/regression tasks (e.g., logistic regression, XGBoost) for success prediction. Multi-label and ordinal classification models may be used where outputs are not binary (e.g., success level: low/medium/high). Time-series behavioral trends may be learned using LSTM and Temporal Convolutional Networks. The output of the decision support engine 270 includes, but is not limited to: a fundability index score (0-100) representing the interviewee's overall attractiveness for investment, a confidence percentile indicating how the interviewee compares against historical data of successful fundraisers, and qualitative recommendations, like “High potential, moderate emotional volatility—recommended for structured mentoring before funding”, “Low deception likelihood with high leadership indicators—immediate term sheet recommended”, etc.

In implementations, the social media engine 280 can leverage social interactions from social media and social networks, such as Facebook®, Twitter®, and LinkedIn®, to determine the impact of social relationships in the context of analyzing risk during the assessment of fundraising operations. Some of the characteristics that can be captured by social interactions include influence, charisma, persuasiveness, connectedness and trustworthiness. In implementations, these social characteristics are computationally derived from social media data using techniques including graph-based metrics (e.g., PageRank, centrality), sentiment analysis, and endorsement analysis. In implementations, the social media data can be applied for determinations done at or by the personality trait determination engine 250, the correlation and behavioral assessment engine 260, the decision support engine 270, or combinations thereof.

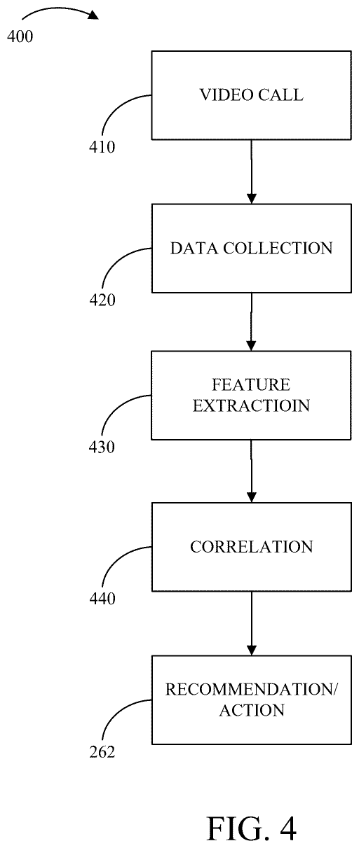

FIG. 4 is a flowchart of an example method 400 for real-time correlation of personality traits based on multimodal interactions for action enablement in accordance with embodiments of this disclosure.

At 410, a video call or video conference call can be initiated between an interviewee, applicant seeking funding for a company, and/or a similarly situated party, and interviewer, venture capitalist, and/or a similarly situated party. The interviewee can upload a presentation and engage in a series of questions and interviews via the videoconference call with the interviewer. During the videoconference call, the applicant can elaborate on the purpose for which the funds are being sought for. During the videoconference call or interview, multimodal data and/or input can be sensed, captured, and/or collected (collectively “collected”) via one or more sensors, such as sensors 215A-215C (and via a multimodal interface) and a data collection engine such as the data collection engine 230.

At 420, the collected multimodal data can be processed by a multimodal recognizer such as the multimodal recognizer 240. The multimodal recognizer and components therein can extract relevant features from the collected multimodal data. In this context, relevant features refer to specific, quantifiable attributes extracted from the multimodal data collected during the videoconference interview. These features include visual cues such as facial action units (e.g., smiles, eyebrow movements), eye gaze patterns, blink rates, and micro-expressions, which are indicative of emotional and cognitive states. From the audio stream, features such as pitch, tone, volume, speaking rate, pauses, and vocal stress patterns are extracted to analyze prosody and emotional valence. The transcribed speech is further processed using NLP techniques to derive linguistic features such as sentiment polarity, lexical diversity, emotional tone, and possible indicators of deception. In some implementations, contextual social signals (e.g., consistency across modalities or credibility inferred from prior interactions or social data) may also be considered.

At 430, the processed multimodal data and extracted features can be processed by a personality trait determination engine to determine personality traits for the interviewee.

At 440, the processed multimodal data and extracted features can be processed by a correlation and behavioral assessment engine to determine behavioral assessments of the interviewee. In implementations, a data processing engine is configured to assess personality traits, social relationship characteristics, and fundraising intents based on the collected multimodal data as recited for 420, 430, and 440. In implementations, the fundraising intents can include determined interviewee and/or applicant intents and behaviors as described herein. In this instance, the correlation and behavioral assessment engine can be a correlation engine configured to determine a relationship between the personality traits, the social relationship characteristics, the fundraising intents and fundraising outcomes.

At 450, the personality traits and the behavioral assessments can be processed by a decision engine to provide real-time recommendations.

In implementations, the decision engine can use a Probit Regression model to decide the chance of funding for an applicant.

Probit regression is used to model dichotomous or binary dependent variables (e.g., funding or not-funding), which uses a probit link function. In this link function, the inverse standard normal distribution of the probability is modeled as a linear combination of the predictors. Assume (i) Y is a binary response variable with outcomes 1 and 0, and (ii) X is the vector of regressors, influence the outcome of Y. The probit model takes the form of:

$$P r ( Y = 1 \vert X ) = Φ ( {X}^{′} \cdot β )$$

where Pr denotes probability, and Φ is the Cumulative Distribution Function (CDF) of the standard normal distribution. The parameter set β is typically estimated by maximum likelihood. That is, β is considered as a column vector of coefficients (model parameters) to be learned. X is a column vector of features (e.g., personality scores, behavioral scores, social metrics). X′ denotes the transpose of the vector X. X′·β indicates the dot product of the feature vector and the coefficient vector (that is, a weighted sum of all the input features), which results in a scalar value.

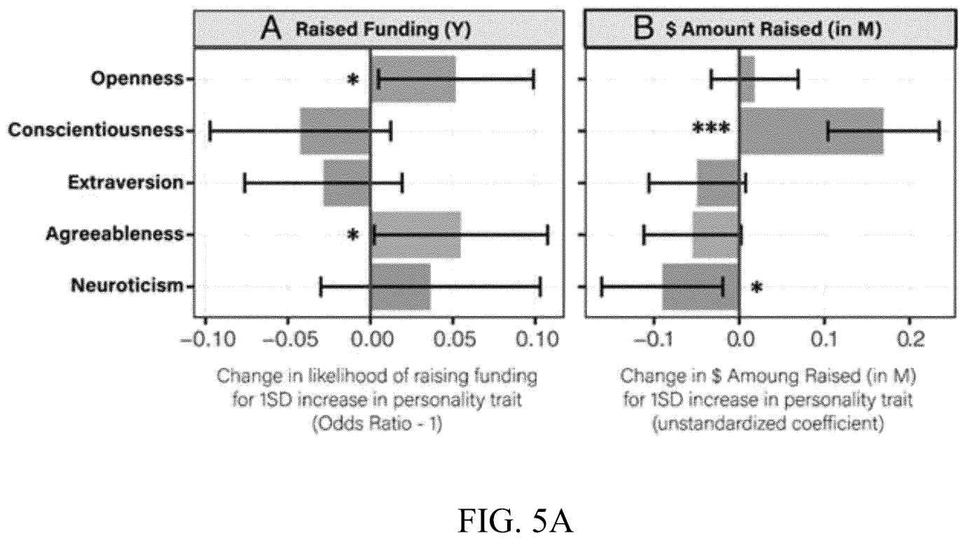

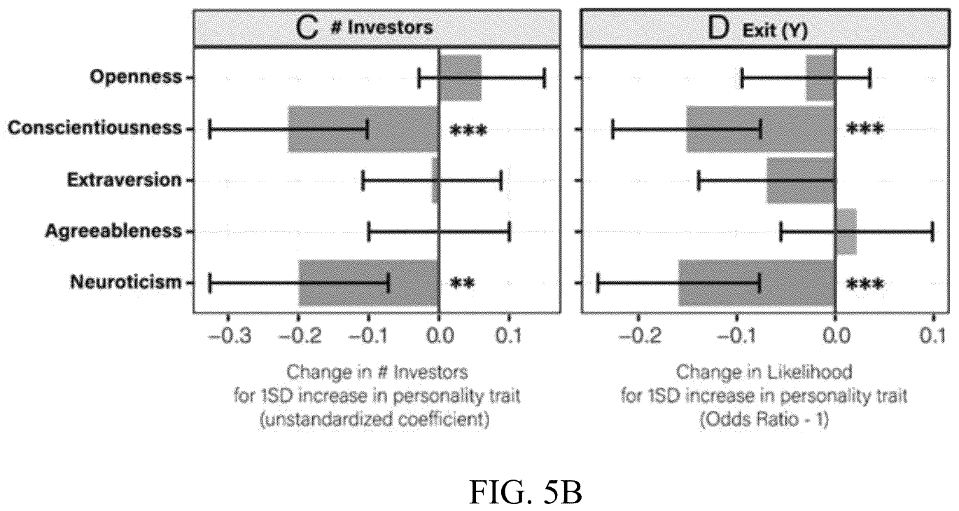

The Probit model provides probability of an event Funding (Y=1). It is essential to capture all possible cases of funding (true positive, TP) but with a minimum number of false categorizations (false positive, FP), that is, for example, predicting non-funding applicants as funding. To achieve this goal, a threshold probability can be used. If the Pr(Y=1) is higher than the threshold probability then the result is Y=1 and vice versa. Ideal value of threshold probability plays an important role in the accuracy of this approach. The best threshold probability is chosen based on the value where TP rate is maximized and FP rate is minimized. Further, the decision engine can incorporate odds ratios to quantify the change in the likelihood of raising funds for a one standard deviation (1SD) increase in each personality trait, providing a quantitative measure of their impact on fundraising success. This is shown in FIGS. 5A and 5B.

To assess the impact of personality on venture success, the me decision engine can incorporate four base personality impact criteria:

### (a) Raised Funding Likelihood Correlation

This criterion evaluates the correlation between an individual's personality traits and their likelihood of successfully raising funding for a venture. Certain personality traits, such as charisma, persuasiveness, and risk-taking propensity, may positively correlate with the ability to secure investment capital from venture capitalists or other investors. Conversely, traits like introversion or risk aversion may negatively impact fundraising efforts.

### (b) Amount Raised Amount Correlation

This criterion examines the correlation between an individual's personality traits and the amount of funding they are able to raise for their venture. Personality characteristics such as confidence, assertiveness, and visionary leadership are associated with higher funding amounts, as investors may perceive individuals with these traits as capable and promising leaders who can drive the venture to success.

### (c) Number of Investors

The number of investors attracted to a venture can be influenced by the personality traits of its founders or leaders. Certain traits, such as communication skills, networking abilities, and trustworthiness, may enhance an individual's appeal to potential investors, leading to a greater number of backers for the venture. Conversely, negative personality traits or a perceived lack of credibility may deter investors, resulting in fewer backers.

### (d) Chance of Exit (Critical)

The likelihood of a successful exit is a critical factor in evaluating the overall success of a venture. Personality traits can impact this aspect through various channels, including decision-making abilities, strategic vision, and adaptability to changing market conditions. Entrepreneurs or leaders with certain personality traits, such as resilience, strategic thinking, and negotiation skills, may increase the likelihood of a successful exit for the venture.

By analyzing the interplay between personality traits and the four base impact criteria, the decision engine and Probit model can provide valuable insights into the potential success of a venture and the role of individual personalities in shaping its trajectory.

In implementations, a method for assessing personality traits in the context of venture capital fundraising includes collecting multimodal interaction data during venture capital interviews, including textual content, vocal characteristics, facial expressions, and behavioral cues, as well as social interactions data from social media platforms such as Facebook, Twitter, and LinkedIn, analyzing the collected data to determine individual personality traits and social relationship characteristics, correlating the identified personality traits and social relationship characteristics with fundraising outcomes, including the likelihood of successfully raising funding, the amount raised, the number of investors attracted, and the chance of exit, and assessing risk during fundraising operations, leveraging natural language processing, computer vision and multimodal analysis tools to analyze the applicant's intents and behaviors during video calls and other interactions, using a Probit Regression model and other statistical methods to determine the probability of funding for an applicant based on the assessed personality traits, social relationships and fundraising intents, incorporating odds ratios to quantify the change in the likelihood of raising funds for a one standard deviation (1SD) increase in each personality trait, thereby providing a quantifiable measure of the impact of personality traits on fundraising success, and providing actionable insights and recommendations based on the correlation analysis to facilitate decision-making in venture capital investment and fundraising processes.

In implementations, a system for discovering personality traits from multimodal interactions in venture capital fundraising includes a data collection modules for capturing textual content, vocal characteristics, facial expressions, and behavioral cues during venture capital interviews and social interactions data from social media platforms, a data processing and analysis modules to assess personality traits, social relationship characteristics, and fundraising intents based on collected data, a correlation and assessment modules to determine the relationship between personality traits, social relationships, fundraising intents and fundraising outcomes, including funding likelihood, amount raised, investor count, and exit potential, and risk assessment, and a decision support modules for providing real-time analysis and actionable insights to venture capitalists and entrepreneurs, aiding in investment decision-making and fundraising strategy optimization.

In implementations, a computer-readable storage medium storing instructions for executing a method for assessing personality traits, social relationships, and fundraising intents in venture capital fundraising, the method includes receiving multimodal interaction data during venture capital interviews and social interaction data from social media platforms, processing the received data to extract features related to textual content, vocal characteristics, facial expressions, behavioral cues, social interactions and fundraising intents, analyzing the extracted features using statistical and machine learning models to identify individual personality traits, correlating the identified personality traits with fundraising outcomes, such as funding likelihood, raised amount, investor count, chance of exit, and risk assessment, integration of odds ratios to quantify the change in the likelihood of raising funds for a one standard deviation (1SD) increase in each personality trait, providing a quantitative measure of the impact of personality traits on fundraising success, and generating reports or recommendations based on the correlation analysis to support venture capital investment decisions and fundraising strategies.

In implementations, a method for computing likelihood correlations between personality traits and fundraising success in venture capital, the method includes collecting data on personality traits and fundraising outcomes for individuals involved in venture capital activities, computing correlation coefficients between each personality trait and fundraising metrics, including likelihood of funding, raised amount, investor count, and exit potential, conducting hypothesis tests to determine the statistical significance of the computed correlations, interpreting the correlation results to assess the impact of personality traits on fundraising success, and validating the findings through sensitivity analyses or independent dataset evaluations to ensure the reliability of the computed correlations.

In implementations, a method for real-time correlation of personality traits from multimodal interactions for venture capital fundraising includes collecting multimodal interactions data during venture capital multimodal interactions with an interviewee, where the multimodal interactions data includes at least textual content, vocal characteristics, facial expressions, and behavioral cues of the interviewee obtained from multiple sensors in a multimodal interface used for the venture capital multimodal interactions, analyzing the collected multimodal interactions data to identify individual personality traits and social relationship characteristics, correlating the identified individual personality traits and the social relationship characteristics with fundraising outcome, leveraging natural language processing, computer vision and multimodal analysis tools to analyze intents and behaviors of the interviewee during the venture capital multimodal interactions, using a statistical model to determine a probability of funding for the interviewee based on the individual personality traits, the social relationship characteristics, the intents, and the behaviors, and providing real-time actionable insights and recommendations based on correlation analysis, intent and behavioral assessment, and probability of funding to facilitate decision-making in venture capital investment and fundraising processes.

In implementations, the multimodal interactions data further includes social interactions data from social media platforms and the method further includes analyzing the social interactions data to determine the social relationship characteristics. In implementations, the method further includes extracting features from the multimodal interactions data using one or more machine learning engines trained on datasets associated with different types of the features. In implementations, the method further includes processing the extracted features using machine learning models trained on psychological frameworks, models, and associated data to determine the individual personality traits. In implementations, the fundraising outcomes include at least a likelihood of successfully raising funding, an amount of funding raised, a number of investors attracted, a chance of exit, and assessing risk during fundraising operations. In implementations, the statistical method is a Probit Regression model. In implementations, the method further includes incorporating odds ratios to quantify a change in a likelihood of raising funds for a one standard deviation increase in each individual personality trait, thereby providing a quantifiable measure of an impact of the individual personality traits on the fundraising outcome.

In implementations, a system for discovering personality traits from multimodal interactions in venture capital fundraising includes data collection sensors configured to capture multimodal data during venture capital interviews and from social media platforms, wherein the multimodal data includes capturing textual content, vocal characteristics, facial expressions, and behavioral cues during the venture capital interviews and capturing social interactions data from the social media platforms, a data processing engine configured to assess personality traits, social relationship characteristics, and fundraising intents based on collected multimodal data, a correlation engine configured to determine a relationship between the personality traits, the social relationship characteristics, the fundraising intents and fundraising outcomes, and a decision support engine configured to provide real-time analysis and actionable insights to venture capitalists and entrepreneurs based on the relationship, aiding in investment decision-making and fundraising strategy optimization.

In implementations, the data processing engine is further configured to extract features from the multimodal data using one or more machine learning engines trained on datasets associated with different types of the features. In implementations, the data processing engine is further configured to process extracted features using machine learning models trained on psychological frameworks, models, and associated data to determine the personality traits. In implementations, the fundraising outcomes include at least a likelihood of successfully raising funding, an amount of funding raised, a number of investors attracted, a chance of exit, and assessing risk during fundraising operations. In implementations, the decision support engine is further configured to use a statistical model to determine a probability of funding for an applicant based on the personality traits, the social relationship characteristics, and the fundraising intents. In implementations, the decision support engine is further configured to incorporate odds ratios to quantify a change in a likelihood of raising funds for a one standard deviation increase in each personality trait, thereby providing a quantifiable measure of an impact of personality traits on the fundraising outcome.

In implementations, a computer-readable storage medium storing instructions for executing a method for assessing personality traits, social relationships, and fundraising intents in venture capital fundraising, the method including receiving multimodal interactions data during venture capital interviews and social interactions data from social media platforms, processing the received multimodal interactions data and the social interactions data to extract defined features, analyzing the extracted features using statistical models and machine learning models to identify individual personality traits, correlating the identified individual personality traits with fundraising outcomes, integrating of odds ratios to quantify a change in a likelihood of raising funds for a one standard deviation (1SD) increase in each individual personality trait, providing a quantitative measure of an impact of individual personality traits on fundraising success, and generating recommendations based on correlation analysis and the quantitative measure to support venture capital investment decisions and fundraising strategies.

In implementations, the fundraising outcomes include at least a likelihood of successfully raising funding, an amount of funding raised, a number of investors attracted, a chance of exit, and assessing risk during fundraising operations. In implementations, a statistical model is a Probit Regression model. In implementations, the recommendations are provided in real-time. In implementations, the defined features are related to textual content, vocal characteristics, facial expressions, behavioral cues, social interactions and fundraising intents.

In implementations, a method for computing likelihood correlations between personality traits and fundraising success in venture capital includes collecting data on personality traits and fundraising outcomes for individuals involved in venture capital activities, computing correlation coefficients between each personality trait and each fundraising outcome, conducting hypothesis tests to determine a statistical significance of the computed correlation coefficients, interpreting correlation results to assess an impact of personality traits on fundraising success, and validating interpretations through sensitivity analyses or independent dataset evaluations to ensure reliability of the computed correlation coefficients.

In implementations, the fundraising outcomes include at least a likelihood of successfully raising funding, an amount of funding raised, a number of investors attracted, a chance of exit, and assessing risk during fundraising operations.

While the embodiments described herein may be susceptible to various modifications and alternative forms, specific embodiments thereof are shown by way of example in the drawings and will be described in detail below. It should be understood, however that these examples not intended to limit the embodiments to the particular forms disclosed, but on the contrary, the disclosed embodiments cover all modifications, equivalents, and alternatives falling within the spirit and the scope of the disclosure as defined by the appended claims.

The method steps have been represented, wherever appropriate, by conventional symbols in the drawings, showing those specific details that are pertinent to understanding the embodiments so as not to obscure the disclosure with details that will be readily apparent to those of ordinary skill in the art having benefit of the description herein.

The terms “comprises,” “comprising,” or any other variations thereof, are intended to cover a non-exclusive inclusion, such that a process, method that comprises a list of steps does not include only those steps but may include other steps not expressly listed or inherent to such process or method. Similarly, one or more elements in a system or apparatus proceeded by “comprises . . . a” does not, without more constraints, preclude the existence of other elements or additional elements in the system or apparatus.

The features of the present embodiments are set forth with particularity in the appended claims. Each embodiment itself, together with further features and attended advantages, will become apparent from consideration of the following detailed description, taken in conjunction with the accompanying drawings.

The disclosed embodiments describe retrieving and organizing information from a set of applications, data sources, or both, by performing various steps as is described in details in forthcoming sections. For the sake explanation and understanding, reference is drawn towards a typical search query where the process heavily relies on multi-modality technology for converging speech, text, images, touch, language, and the like. Success of such a multi-modality platform mainly depends on how good and relevant the obtained results are.

Having described and illustrated the principles with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein.

Elements of the described embodiments shown in software may be implemented in hardware and vice versa. As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine-readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory. Modules can be defined by executable code stored on non-transient media.

The following description is presented to enable a person of ordinary skill in the art to make and use the embodiments and is provided in the context of the requirement for a obtaining a patent. The present description is the best presently-contemplated method for carrying out the present embodiments. Various modifications to the embodiments will be readily apparent to those skilled in the art and the generic principles of the present embodiments may be applied to other embodiments, and some features of the present embodiments may be used without the corresponding use of other features. Accordingly, the present embodiments are not intended to be limited to the embodiments shown but are to be accorded the widest scope consistent with the principles and features described herein.

What is claimed is:

1. A method for real-time correlation of personality traits from multimodal interactions for venture capital fundraising, comprising:
collecting multimodal interactions data during venture capital multimodal interactions with an interviewee, wherein the multimodal interactions data includes at least textual content, vocal characteristics, facial expressions, and behavioral cues of the interviewee obtained from multiple sensors in a multimodal interface used for the venture capital multimodal interactions;
analyzing the collected multimodal interactions data to identify individual personality traits and social relationship characteristics;
correlating the identified individual personality traits and the social relationship characteristics with fundraising outcomes;
leveraging natural language processing, computer vision and multimodal analysis tools to analyze intents and behaviors of the interviewee during the venture capital multimodal interactions;
using a statistical model to determine a probability of funding for the interviewee based on the individual personality traits, the social relationship characteristics, the intents, and the behaviors; and
providing real-time actionable insights and recommendations based on correlation analysis, intent and behavioral assessment, and probability of funding to facilitate decision-making in venture capital investment and fundraising processes.

2. The method of claim 1, wherein the multimodal interactions data further includes social interactions data from social media platforms and the method further comprising:
analyzing the social interactions data to determine the social relationship characteristics.

3. The method of claim 1, the method further comprising:
extracting features from the multimodal interactions data using one or more machine learning engines trained on datasets associated with different types of the features.

4. The method of claim 3, the method further comprising:
processing the extracted features using machine learning models trained on psychological frameworks, models, and associated data to determine the individual personality traits.

5. The method of claim 1, wherein the fundraising outcomes include at least a likelihood of successfully raising funding, an amount of funding raised, a number of investors attracted, a chance of exit, and assessing risk during fundraising operations.

6. The method of claim 1, wherein the statistical method is a Probit Regression model.

7. The method of claim 1, the method further comprising:
incorporating odds ratios to quantify a change in a likelihood of raising funds for a one standard deviation increase in each individual personality trait, thereby providing a quantifiable measure of an impact of the individual personality traits on the fundraising outcome.

8. A system for discovering personality traits from multimodal interactions in venture capital fundraising, comprising:
data collection sensors configured to capture multimodal data during venture capital interviews and from social media platforms, wherein the multimodal data includes capturing textual content, vocal characteristics, facial expressions, and behavioral cues during the venture capital interviews and capturing social interactions data from the social media platforms;
a data processing engine configured to assess personality traits, social relationship characteristics, and fundraising intents based on collected multimodal data;
a correlation engine configured to determine a relationship between the personality traits, the social relationship characteristics, the fundraising intents and fundraising outcomes; and
a decision support engine configured to provide real-time analysis and actionable insights to venture capitalists and entrepreneurs based on the relationship, aiding in investment decision-making and fundraising strategy optimization.

9. The system of claim 8, wherein the data processing engine is further configured to:
extract features from the multimodal data using one or more machine learning engines trained on datasets associated with different types of the features.

10. The system of claim 8, wherein the data processing engine is further configured to:
process extracted features using machine learning models trained on psychological frameworks, models, and associated data to determine the personality traits.

11. The system of claim 8, wherein the fundraising outcomes include at least a likelihood of successfully raising funding, an amount of funding raised, a number of investors attracted, a chance of exit, and assessing risk during fundraising operations.

12. The system of claim 8, wherein the decision support engine is further configured to:
use a statistical model to determine a probability of funding for an applicant based on the personality traits, the social relationship characteristics, and the fundraising intents.

13. The system of claim 12, wherein the decision support engine is further configured to:
incorporate odds ratios to quantify a change in a likelihood of raising funds for a one standard deviation increase in each personality trait, thereby providing a quantifiable measure of an impact of personality traits on the fundraising outcome.

14. A computer-readable storage medium storing instructions for executing a method for assessing personality traits, social relationships, and fundraising intents in venture capital fundraising, the method comprising:
receiving multimodal interactions data during venture capital interviews and social interactions data from social media platforms;
processing the received multimodal interactions data and the social interactions data to extract defined features;
analyzing the extracted features using statistical models and machine learning models to identify individual personality traits;
correlating the identified individual personality traits with fundraising outcomes;
integrating of odds ratios to quantify a change in a likelihood of raising funds for a one standard deviation (1SD) increase in each individual personality trait, providing a quantitative measure of an impact of individual personality traits on fundraising success; and
generating recommendations based on correlation analysis and the quantitative measure to support venture capital investment decisions and fundraising strategies.

15. The computer-readable storage medium of claim 14, wherein the fundraising outcomes include at least a likelihood of successfully raising funding, an amount of funding raised, a number of investors attracted, a chance of exit, and assessing risk during fundraising operations.

16. The computer-readable storage medium of claim 14, wherein a statistical model is a Probit Regression model.

17. The computer-readable storage medium of claim 14, wherein the recommendations are provided in real-time.

18. The computer-readable storage medium of claim 14, wherein the defined features are related to textual content, vocal characteristics, facial expressions, behavioral cues, social interactions and fundraising intents.

19. A method for computing likelihood correlations between personality traits and fundraising success in venture capital, comprising:
collecting data on personality traits and fundraising outcomes for individuals involved in venture capital activities;
computing correlation coefficients between each personality trait and each fundraising outcome;
conducting hypothesis tests to determine a statistical significance of the computed correlation coefficients;
interpreting correlation results to assess an impact of personality traits on fundraising success; and
validating interpretations through sensitivity analyses or independent dataset evaluations to ensure reliability of the computed correlation coefficients.

20. The method of claim 19, wherein the fundraising outcomes include at least a likelihood of successfully raising funding, an amount of funding raised, a number of investors attracted, a chance of exit, and assessing risk during fundraising operations.
